(19) United States
(12) Patent Application Publication
(10) Pub. No.: US 2006/0097004 A1
(43) Pub. Date: May 11, 2006

(54) Water toy with two port elastic fluid bladder

(76) Inventor: Eric Junkel, Des Plaines, IL (US)

Correspondence Address: GIFFORD, KRASS, GROH, SPRINKLE & CITKOWSKI, P.C, PO BOX 7021, TROY, MI, 48007-7021, US

(21) Appl. No.: 11/249,579

(22) Filed: Oct. 13, 2005

Related U.S. Application Data
(62) Division of application No. 10/419,012, filed on Apr. 18, 2003.

(51) Int. Cl. B05B 11/00

(52) U.S. Cl. 222/78

(57) ABSTRACT

A water discharge toy including an elastomeric bladder having a substantially elongated shape with a first end and second end. A control valve includes a first fitting and is connected to the first end of the bladder and further exhibits an outflow orifice, the control valve further being capable of actuated to fluidly communicate the bladder with the outflow orifice. A one-way flow valve includes a second fitting connected to the second end of the bladder and is adapted to being engaged by a fill adapter to provide a source of pressurized fluid to the elastomeric bladder and such as to refill the bladder.

### CROSS REFERENCE TO RELATED APPLICATIONS

The present application is a divisional application of U.S. patent application Ser. No. 10/419,012, filed Apr. 18, 2003, and entitled “Water Toy With Two Port Elastic Fluid Bladder”.

### BACKGROUND OF THE INVENTION

1. Field of the Invention

The present invention relates generally to fluid discharging devices. More particularly, the present invention discloses a fluid discharging water toy incorporating an elastic and fluid carrying bladder for producing a continuous stream of liquid, combined with a first controlled flow discharge port (nozzle) for producing a continuous stream or spray of fluid, and a second, one-way flow refilling port.

2. Description of the Prior Art

The prior art is well documented with examples of elastic-walled pressure vessels having both refillable and discharge capabilities. Such elastic-wall pressure vessels are used in several different applications and can be divided into such as aerosol-can replacement dispensers, slow, constant feed rate dispensers, garden-sprayer type dispensers, and water squirt toys with enclosed or non-enclosed bladders.

Selected and pertinent examples of the prior art include first referencing U.S. Pat. No. 3,486,539, issued to Jacuzzi, and which teaches a liquid dispensing and metering assembly for use in the medical profession and which is capable of supplying liquid at a substantially constant flow rate and pressure rate over a substantial period of time. The Leeper U.S. Pat. No. 4,419,096 patent teaches an elastomeric bladder assembly designed for operation at constant pressure and in order to maintain a constant dispensing rate for its contents.

U.S. Pat. No. 5,137,175, issued to Kowalski, teaches a fluid storing and dispensing apparatus having a tubular rubber bladder capable of storing a fluid. A valve regulates fluid flow from the bladder and a support maintains the bladder in a longitudinally stretched condition to initiate desired inherent properties that provide a substantially constant fluid discharge pressure and a greater number of fill cycles prior to bladder failure than is obtainable with an unstretched bladder. Additional embodiments include the provision of a container which surrounds and restricts the maximum diameter of the bladder to limit lateral deformation and thereby increase the number of fill cycles prior to bladder failure.

U.S. Pat. No. 4,798,313, issued to Farley, discloses an elastomeric bladder for dispensing ice cream and which includes a tubular and expandable elastic container for holding and dispensing a frozen confection as it thaws. The frozen confection holds the container in an expanded configuration and, as it thaws, the contraction of the container forces thawed frozen confection from an open end of the container. A whistle provided at the open end of the container and a valve in the whistle structure prevents air from entering the container when a user blows air into the whistle.

Of the prior art related to water spray dispensers, relevant examples include the water gun device of Paranay et al., U.S. Pat. No. 4,257,460. Paranay teaches a body formed with a central bore opening at its opposite end and to provide a discharge nozzle at one end of the body and a storage compartment or reservoir end at the opposite end of the body. The storage compartment end is adapted to releasably hold the end of an inflatable member which, when loaded with water under pressure, expands so as to stretch the membrane of the inflatable storage compartment. Upon termination of the loading pressure, the inflatable member collapses under its own elasticity to discharge the stored water via the nozzle end of the body. A clamping device is employed for detachably connecting the inflatable storage compartment to its respective end of the body and a trigger mechanism may be employed for selectively releasing the pressurized water within the storage compartment.

U.S. Pat. No. 5,174,477, issued to Schafer, teaches a water squirt toy including a length of elastic tubing with a nozzle positioned at one end and a clip about the other end. A protective and pliable tubular sleeve is positioned about the elastic tubing and is attached to one end of the tubing by the clip. The nozzle may include any type of squirt nozzle and which has small tubular inserts or the bottom portion of a ballpoint pen barrel.

U.S. Pat. No. 6,193,107, issued to D'Andrade, teaches a toy water gun including a housing, an ejection nozzle, a bladder and an outlet connection which runs from the bladder to the nozzle. The expandable bladder is located within the housing and has a first end connected to the outlet connection and a carriage attachment located at the second end and which is movable linearly within the housing to expand the bladder. The bladder in turn is provided as a tubular member having a weakened section with a larger diameter than the remaining portion of the tubular member and which has a variable diameter which varies from larger at the first end to smaller at the second end. In one embodiment, the bladder includes a variable diameter between first and second ends and, in another, a constant diameter with a varying wall thickness gradient. Also, combined variable diameters and wall thicknesses may be used.

A final example of the prior art is set forth in U.S. Pat. No. 5,667,419, issued to Spector, and which teaches a water pistol of conventional construction and animal figure assembly, in which the pistol is concealed within an animal figure and such that water discharged from the pistol is caused to spit out of the animal's mouth. The animal figure includes a head having an open mouth and a body having an internal cavity, which communicates with the head, and is open at its rear end to permit insertion of the refillable water pistol.

### SUMMARY OF THE PRESENT INVENTION

The present invention is a water discharge toy capable of producing a steady stream of a water or spray mist. The toy in a first preferred embodiment includes an elastomeric bladder having a substantially elongated shape with a first end and a second end.

A control valve is provided and includes a first compression fitting connected to the first end of the bladder. The control valve exhibits an outflow orifice, typically an extending and interiorly hollowed nozzle lumen, and is actuated to fluidly communicate the bladder with the outflow orifice and in order to discharge the contents of the bladder in a steady and continuous pressure fashion.

In a preferred variant, the control valve includes a bulbous shaped and depressible body into which are designed cantilevered springs. Pinch members are interconnected with the cantilevered springs and normally pinch closed in opposing fashion the forward extending end of the elastomeric bladder. Upon depressing the bulbous shaped body, actuation of the cantilevered springs in turn causes the pinch members to unseat and to permit fluid flow from the elastomeric bladder through the outflow orifice.

A one-way flow valve, selected from such as a flapper valve or displaceable ball valve, is incorporated into a valve body and secured to a second, typically rear, end of the elastomeric bladder. A fill adapter is capable of being fluidly and sealingly engaged to the valve body, typically through slot and bayonet fittings defined therebetween, and in order to refill the elastomeric bladder as desired.

A flexible sleeve may be provided, also including a substantially elongated shape and arranged about the elastomeric bladder. The sleeve connects at a first end to a restriction bladder associated with the first compression fitting and at a second end to the second compression fitting associated with the one-way flow valve. The sleeve further exhibits an expanded cross-sectional area no greater than a corresponding area of the filled elastomeric bladder and to provide an overall animal or snake-like appearance to the device.

Additional variants of the invention include designing the water discharge toy with a rear configured and bulbous shaped elastomeric bladder, the purpose being to achieve a substantially insect or spider-like appearance with the application of a suitable decorative covering. It is also contemplated that the bulbous-shaped control valve can be substituted by a pushbutton valve built into an elongated and interiorly hollowed body to which an extending aperture portion of the bulbous shaped bladder interconnects.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a top plan view, in partial cutaway, and illustrating the water toy device according to the present invention;

FIG. 2 is ninety degree rotated side view of the water toy device according to FIG. 1, again in partial cutaway, and illustrating the features of the depressible control valve and attachable fill adapter;

FIG. 3 is a sectional illustration of an axial type compression fitting associated with the rear fill port of the water toy device according to the present invention;

FIG. 4 is a sectional illustration of split bushing halves incorporated in an interference fitting fashion with the compression fitting and outer loop attachment;

FIG. 5 is a sectional illustration of a check valve configuration, according to a further preferred embodiment, associated with the rear fill port of the water toy device and including a flapper valve displaced from a valve seat;

FIG. 5A is an illustration of a one-way check valve utilizing a ball as a gate;

FIG. 5B is an illustration of the check valve of FIG. 5A in combination with an inlet plenum of a fill adapter attached to a source of pressurized water;

FIGS. 6, 6A and 6B illustrate progressive illustrations of the elastic tubular bladder of the water toy device being filled;

FIGS. 7-7D illustrate several examples of coupling arrangements for fill adapters according to the present invention;

FIGS. 8, 8A and 8B are illustrations of compression fitting details and including a lateral split bushing employed for sealing the forward nozzle lumen of the water discharge toy according to the present invention;

FIGS. 9, 9A and 9B illustrate various examples of additional fill adapter options according to the present invention;

FIG. 10 is an illustration of a fill adapter manifold according to a yet further variant of the present invention;

FIG. 11 is an illustration of a fill stand adapter for use with the water discharge toy according to the present invention;

FIG. 12 is an illustration of a water discharge toy according to a further preferred embodiment of the present invention and illustrating a sideways disposed fill port and rearward disposed elastic bladder;

FIGS. 13-13C illustrate a series of sectional views of the pressure sensitive flow control valve according to the present invention;

FIGS. 14-14C illustrate a series of views of a pinch valve arrangement employed with a flow control valve according to the present invention;

FIGS. 15, 15A and 15B are collapsible pinch valves associated with a flow control valve and according to a further preferred variant of the present invention;

FIG. 16 is an illustration of a remote control transmitter and receiver/driver unit for remotely activating the water discharge toy according to the present invention;

FIG. 17 is an illustration of a remote control cable attachment for activating the water discharge toy according to the present invention;

FIGS. 18 and 18A are assembled and exploded views, respectively, of a water discharge toy employing a replaceable bladder according to a further preferred variant of the present invention;

FIG. 19 is an illustration of a water discharge toy according to a still further variant of the present invention;

FIGS. 20 and 20A illustrate additional views of an animal figure employed in the water discharge toy according to the variant of FIG. 19; and

FIGS. 21 and 21A illustrate first and second sectional views, respectively, of a nozzle associated with the water toy device of the present invention and adjustable between spray and collimated stream positions.

### DETAILED DESCRIPTION OF THE PREFERRED EMBODIMENTS

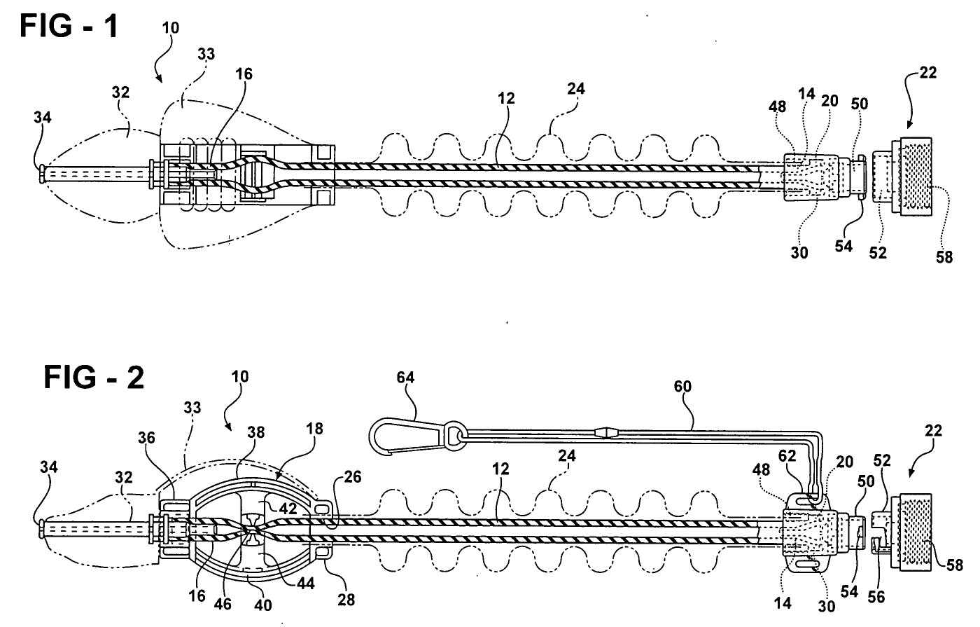

Referring now to FIGS. 1 and 2, a water discharge toy is illustrated at 10 according to a first preferred embodiment of the present invention. As previously explained, the water discharge toy of the invention is an improvement over prior art water squirt/discharge devices, which are typically produced along the “weapon-like” or “gun” concept, and, in a preferred embodiment, provide a fun, non-threatening animal or insect design squirt toy capable of issuing a steady stream or misting spray of water. It is however again understood that the present invention resides in the construction and arrangement of the components it sets forth and, accordingly, additional potential variants can include weapon-designed embodiments.

Referring again to FIGS. 1 and 2, the essential components of the water discharge toy 10 include an elongated and elastomeric bladder 12 (shown in a deflated or unfilled position) and including a first (rearward) end 14 and a second (forward) end 16. A control valve 18 connects to a forward end location, or second end 18, of the elastomeric bladder. A one-way flow valve 20 secures to a rear end location, or first end 16, of the bladder and is further adapted to being engaged by a fill adapter 22 to provide a source of a pressurized fluid (not shown) to the elastomeric bladder 12.

A flexible sleeve 24 is provided having a substantially elongated shape and which is arranged about the elastomeric bladder 12. The flexible sleeve 24 exhibits an expanded cross-sectional area no greater than a corresponding cross-sectional area of the elastomeric bladder 12 in a fully filled condition. As further illustrated, the flexible sleeve 24 connects at a first end 26 (see FIG. 2) to a bushing 28, formed as part of a handle assembly and which prevents the bladder 12 from expanding into the control valve mechanism. The flexible sleeve 24 connects at a second end 30 to a second compression fitting associated with the one-way flow valve 20. The sleeve 24 is further configured, along with a decorative head design 32, to emulate a snake-like appearance.

Additional features of the control valve 18 include an outflow orifice, typically in the shape of a nozzle lumen 34, extending from a forward end location of the control valve 18 and around which is arrayed the decorative snake head 32 and decorative body 33. A split bushing 36 is provided for engaging about the compression fitting associated with the control valve 18 and to sealingly engage the forward end of the control valve. It is also envisioned that, in an alternate embodiment, the flexible sleeve can terminate at its first end with the split bushing 36.

The control valve 18, in the preferred embodiment, further includes a substantially bulbous shaped and depressible body incorporating first and second cantilevered springs 38 and 40. First and second flow interrupting members 42 and 44 are interconnected with the first and second cantilevered springs and engage a location 46 of the elastomeric bladder 12 in opposing fashion to close off fluid flow through the bladder. Upon the control valve body being depressed, the cantilevered springs 38 and 40 are inwardly deflected, causing the interrupting members 42 and 44 to disengage, and as will be subsequently discussed in additional detail, from their opposing and flow disrupting relationship relative to the bladder 12, and to thereby permit fluid flow from the elastomeric bladder 12 through the outflow orifice 34.

Additional components of the one-way flow valve 20 include a valve body defining, in a first or forward facing direction, an annular seating configuration for receiving and seatingly engaging the end 14 of the bladder 12 and an associated end 48 of the flexible sleeve 24. The valve body defines, in a second or rearward facing direction, an inlet plenum 50 for receiving an associated engagement portion 52 of the fill adapter 22.

In particular, a bayonet tab and slot relationship may be defined between the plenum 50 and engagement portion 52 (as illustrated at 54 and 56, respectively in FIGS. 1 and 2) and in order to fluidly seal and mechanically interconnect the two components together. The fill adapter 22 further includes a plurality of interiorly arrayed threads 58 for threadably engaging an associated and exteriorly threaded end of a garden hose (again not shown). As further again illustrated in FIG. 2, a strap 60 is secured to at least an integral attachment portion 62 associated with the one-way valve assembly, the strap further including a clip end 64.

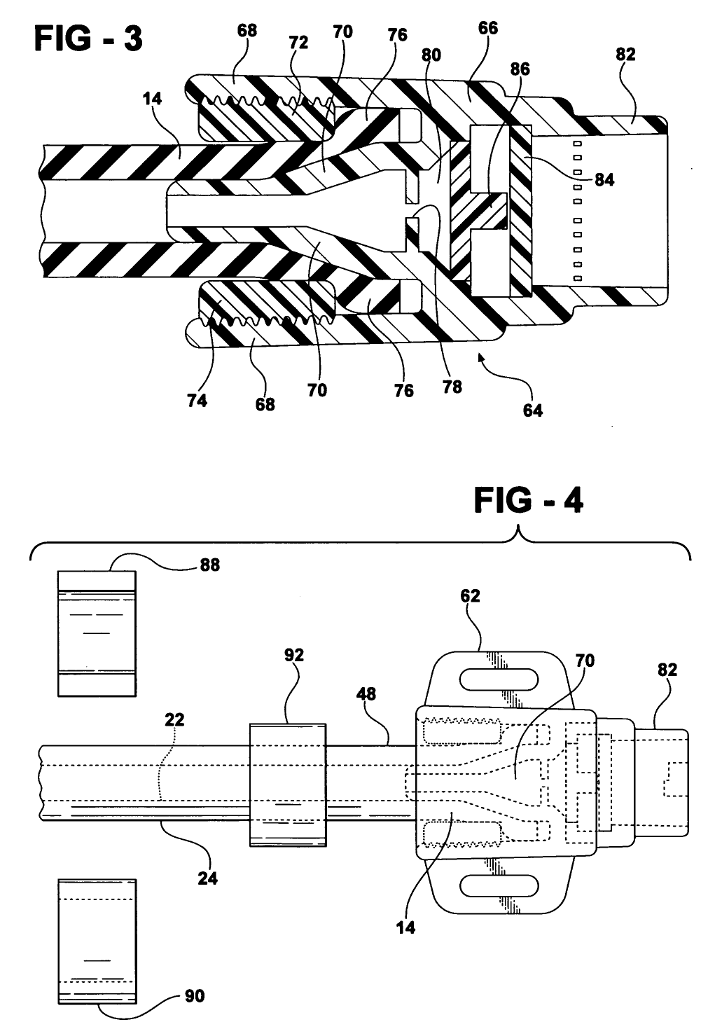

Referring now to the succeeding illustrations, various sectional views are shown of both the preferred variant of FIGS. 1 and 2, as well as alternative variants contemplated within the scope of the invention. Referring first to FIG. 3, a sectional illustration is shown at 64 of an axial type compression fitting associated with the rear fill port of the water toy device according to the present invention. This arrangement corresponds in placement to the one-way control valve generally illustrated at 20 in FIGS. 1 and 2, and includes a valve body 66 exhibiting the first (forward) facing end and within which is defined the annular shaped receptacle for receiving the extending end 14 of the elastomeric bladder 12.

In particular, the annular shape is defined by outer 68 and inner 70 circular shaped portions, between which are sandwiched the extending 14 of the bladder 12 along with a pair of split bushings 72 and 74 with crush ribs arranged on their outer surfaces. In this fashion, the terminating ends 76 of the elastic bladder are configured in the manner illustrated in FIG. 3. A fluid regulator orifice 78 is illustrated between the generally conical shaped configuration of the central nipple which defines the inner shaped portion 70 and an outlet plenum side 80 in communication with inlet plenum 82.

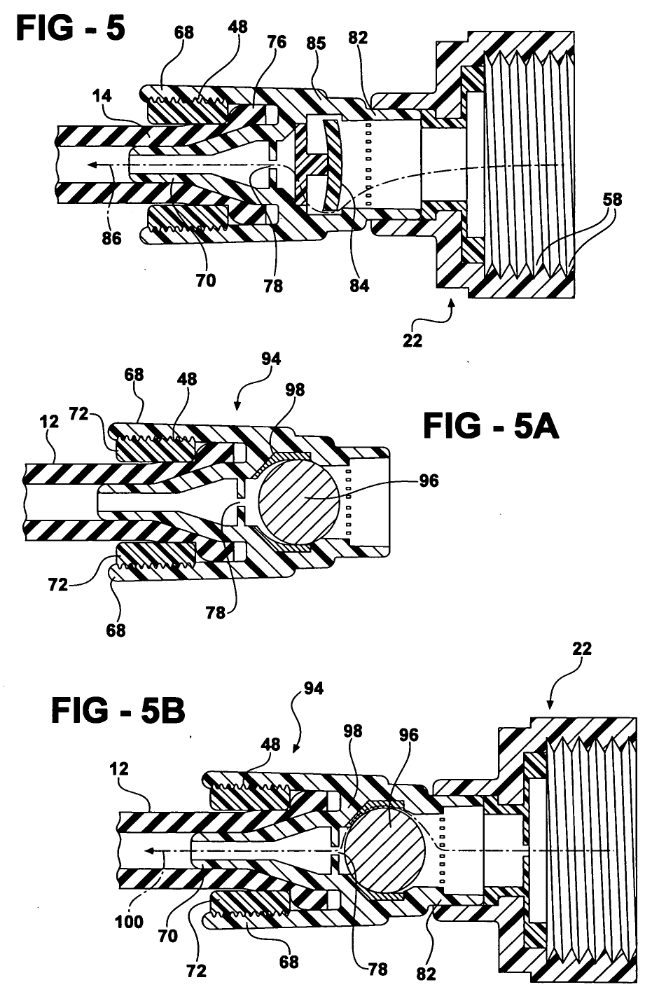

A flapper valve 84 is provided and is mechanically supported at 85. The flapper valve 84 operates, upon application of an inlet fluid pressure of specified force through the inlet plenum 82, to unseat and to deflect, as shown in FIG. 5, and to permit fluid flow to pass through the valve and in the direction of fluid stream 86 associated with flapper valve 84. As further illustrated in FIG. 4, split bushing halves 88 and 90 are assembled together, see further at 92, and are installed in slidable and friction engaging fashion in an annular space defined between the integral fitting 62 and the compressed end 14 of the elastomeric bladder 12.

Referring further to FIG. 5A, an illustration is shown at 94 of a one-way check valve utilizing a ball 96 as a gate and in substitution of the flapper 84 illustrated in FIGS. 3 and 5. The one-way valve is substantially identically shown as in the previous figures, with the exception of the mechanical seat being reconfigured as at 98. Referring further to FIG. 5B, the ball 96 unseats in the manner illustrated upon fluidic communication of the inlet plenum to the fill adapter and to again permit fluid flow according to the path 100 illustrated.

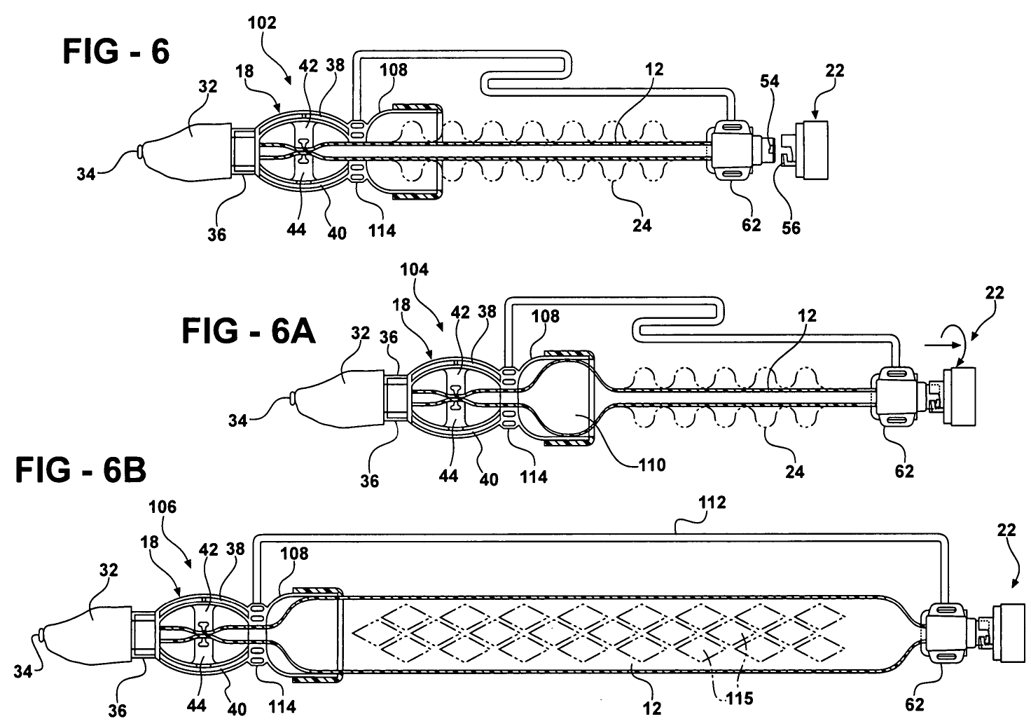

FIGS. 6, 6A and 6B illustrate progressive illustrations of the elastic tubular bladder of the water toy device being filled and as are shown at 102, 104 and 106, respectively. In particular, and viewing first FIG. 6, the female part 56 of the bayonet connector (this again associated with the fill adapter 22) is attached in a twisting fashion to the associated male part 54 on the inlet plenum and prior to activating the externally attachable fluid supply (garden hose fitting, etc.). At this point, the bladder 12 is ready to be filled and an additional component of the design includes the provision of a constriction ring 108 to prevent over-expansion of the bladder 12 during its initial filling, see further at 110 in FIG. 6A. Referring finally again to FIG. 6B, the tubular bladder is shown filled to capacity and a variation of a carrying strap is illustrated at 112 connected at a rear end to the integral fitting 62 and at a forward end to a cylindrical ring portion 114 associated with an intermediate location between the control valve and constriction ring. As further illustrated in FIG. 6B, a multiple diamond shaped pattern 115 is illustrated and which replicates an overall snake-like design.

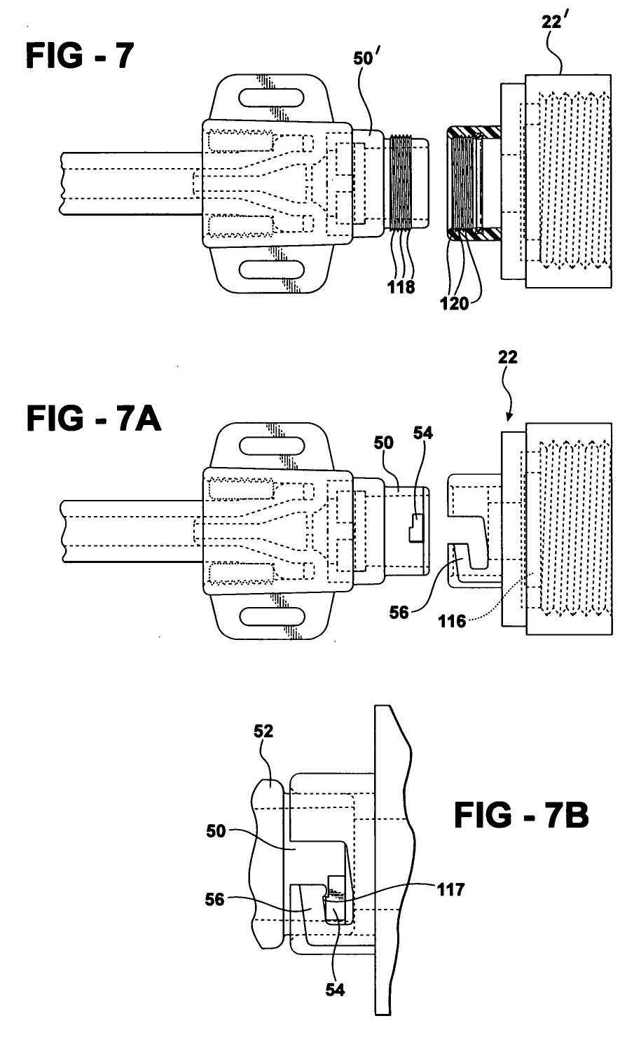

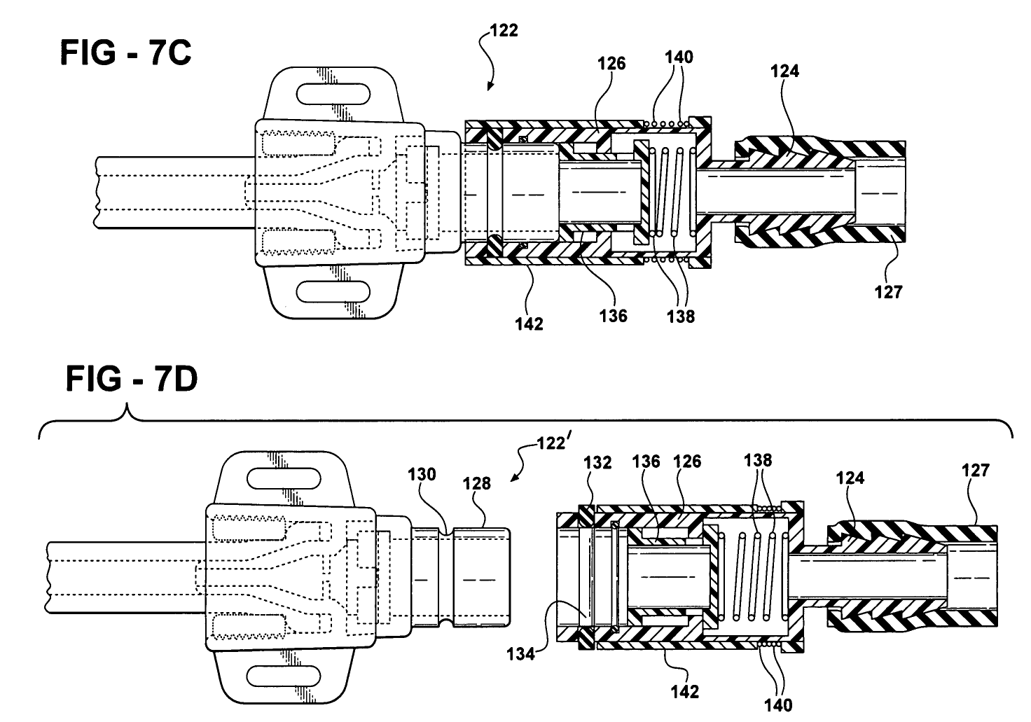

With further reference to FIGS. 7-7D in succession, illustrated are several examples of coupling arrangements for fill adapters according to the present invention. In particular, FIGS. 7A and 7B repeat in substance the features illustrated and described in reference to the previous figure illustrations and which again include the bayonet tab configuration for interconnecting the fill adapter 22 to the inlet plenum 50. The bayonet tab configuration may further be substituted by a screw type connection or quick-connect attachment, all within the ordinary skill of one in the relevant art. Such further includes provision of a gasket 116 in the fill adapter 22 and for sealing the fluid flow delivered from the external hose fitting (not shown). FIG. 7B provides a close up partial illustration of the wedge feature 117 provided between the twistingly interengaging tab and slot arrangement.

FIG. 7 is a close approximation to the illustration of FIG. 7A, with the exception that the bayonet tab and slot arrangement is replaced by a first plurality of externally arrayed threads 118 on the inlet plenum 50′ and which rotatably interengage with additional threads 120 arranged on fill adapter 22′.

FIGS. 7C and 7D illustrate respective engaged 122 and disengaged 122′ views of a still further design variation of inlet plenum and fill adapter, the notable variation here being the provision of an extended barb fitting 124 extending rearwardly from a spool valve 126 and which frictionally and sealingly engages within an interior wall surface of a flexible conduit tubing or the like 127 and through which fluid flow is initiated. As best shown in FIG. 7D, a projecting end of a further designed inlet plenum 128 includes an annular shaped recess 130, within which is seated inwardly biasing pins 132 upon inserting the extending inlet plenum end 128 within a hollowed end interior 134 defined in the spool valve 126.

A valve gate 136 is provided within the spool valve 126 and, upon being engaged in the fashion illustrated in FIG. 7C, allowed fluid flow to communicate through the fill adapter, inlet plenum and across the one-way spool valve and into the elastomeric bladder. See also biasing spring 138 associated with the valve gate 136, as well as spring 140 with an outer displaceable sleeve 142 of the spool valve 126 and which displaces to the position of FIG. 7D to outwardly unseat the pins 132 and to permit detachment from the inlet plenum 128.

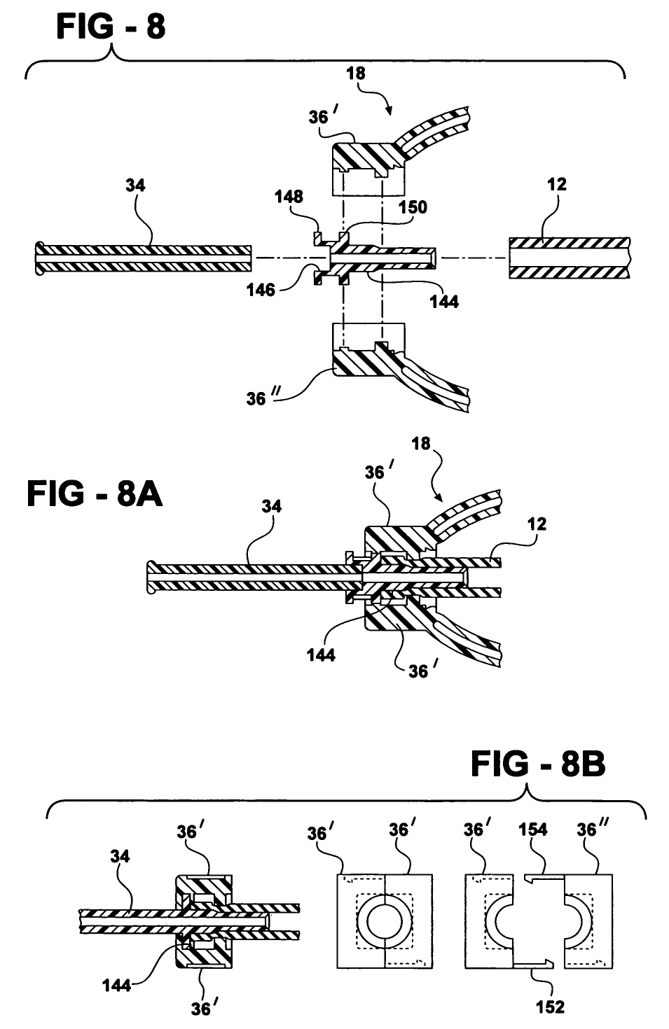

Referring now to FIGS. 8, 8A and 8B, additional illustrations are shown of compression fitting details associated with the control valve 18 and which include a lateral split bushing, see at 36′ and 36″, employed for sealing the forward nozzle lumen 34 of the water discharge toy. An additional fitting tube is illustrated at 144 and, as best shown in FIG. 8, includes an aperture 146 for receiving the inserting end of the lumen tube 34, rib 148, for seating and retaining the animal figure (see at 32 in FIG. 1) and rib 150 for seating and retaining the split bushing (36′ and 36″) upon assembly. The illustration of FIG. 8B further shows in end facing fashion the split bushing portions 36′ and 36″ and in particular cantilevered snap portions 152 and 154 for interengaging the bushing portions together.

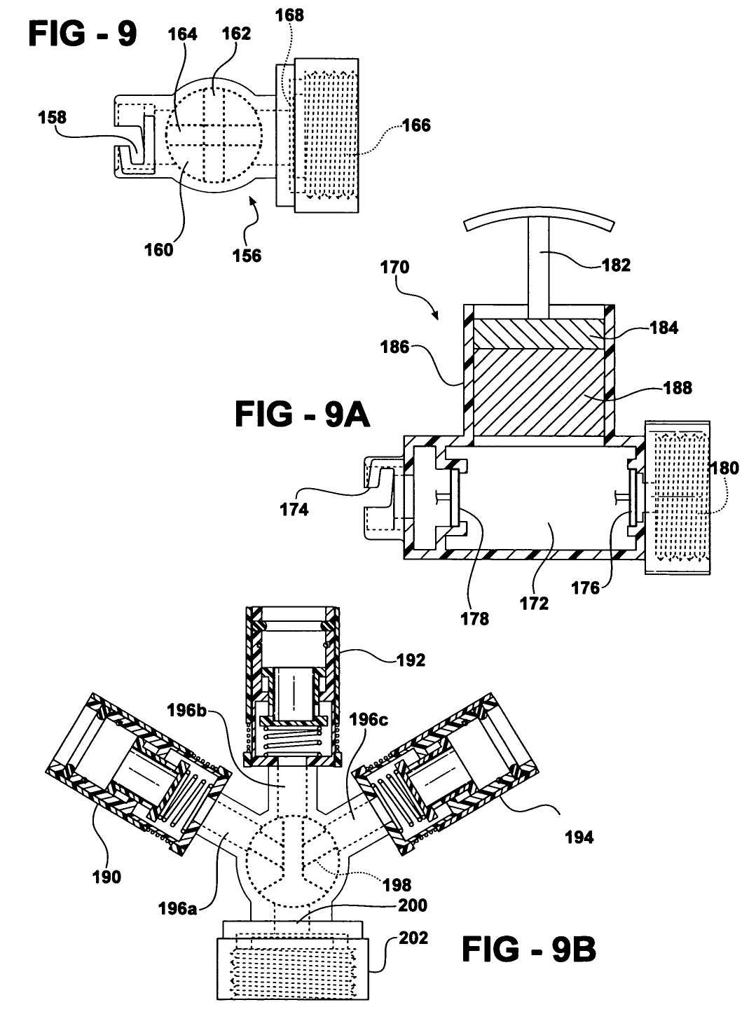

Referring now to FIGS. 9, 9A and 9B, illustrated are various examples of additional fill adapter options according to the present invention. FIG. 9 illustrates, at 156, one fill adapter option (contrasting to general illustration 22 in FIG. 1) and in which a valve body includes again the female bayonet connector receptacle 158 at a forwardly disposed end. A ball valve 160 is disposed within a suitably configured channel in the valve body and includes a fluid passageway illustrated in both closed 162 and opened 164 orientations. Additional features repeated from the earlier disclosed variant include internally threaded fittings 166 and a sealing end gasket 168 for communicating fluid flow to the valve body.

FIG. 9A illustrates a further variation 170 of fill adapter in which an adapter manifold 172 is provided, again including a female bayonet connector receptacle 174 at a forwardly disposed end. An inlet check valve is shown at 176 and an outlet check valve at 178, at substantially opposite ends of the adapter manifold 172, and internally threaded fittings 180 are again shown to facilitate connection of an externally threaded hose fitting or the like. Additional features of this design variant include a pump actuator 182 which drives a piston 184 seated within an annular housing 186 in communication with the adaptor manifold 172. Upon depressing the pump actuator 182 and piston 184 an internal displacement volume 188 of fluid is impelled into the manifold and, by virtue of increased fluid pressure resulting from iterative pumping cycles, causes additional pressurized fluid flow into the elastomeric bladder.

Referring to FIG. 9B, a series of three quick connects 190, 192, and 194 are illustrated and which are associated, respectively, with a like plurality of three outlet manifolds 196a, 196b and 196c. A three position valve gate 198 selectively communicates a given manifold and associated quick connect and additional components such as an inlet plenum 200 and fill adapter 202 are again shown and by which three position filling of the water discharge toy is made possible.

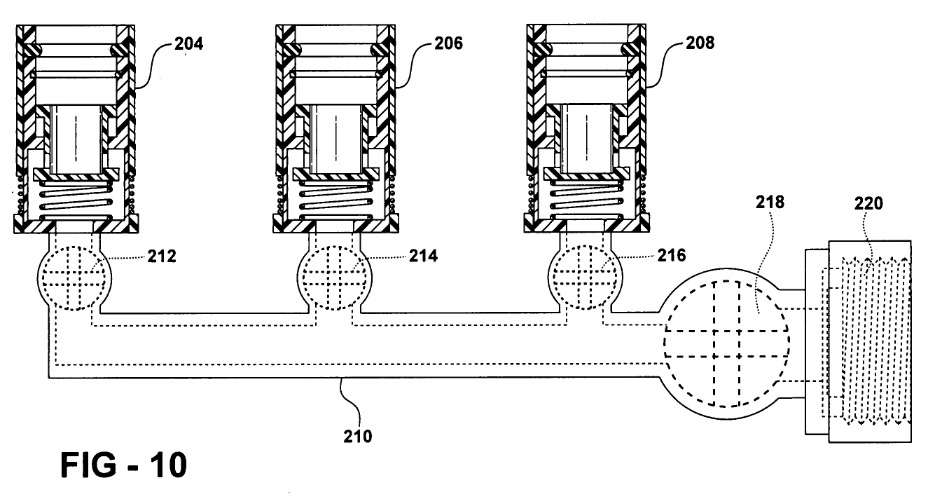

FIG. 10 is an illustration of a yet further fill adapter manifold arrangement according to the present invention and by which quick connects 204, 206 and 208 are illustrated in series along an adapter manifold 210. In contrast to the variant of FIG. 9B, a gate valve (see at 212, 214 and 216, respectively) is provided for each quick connect and, in cooperation with a main on/off gate valve 218, communicates flow to a fill adapter 220 with interengaging threads.

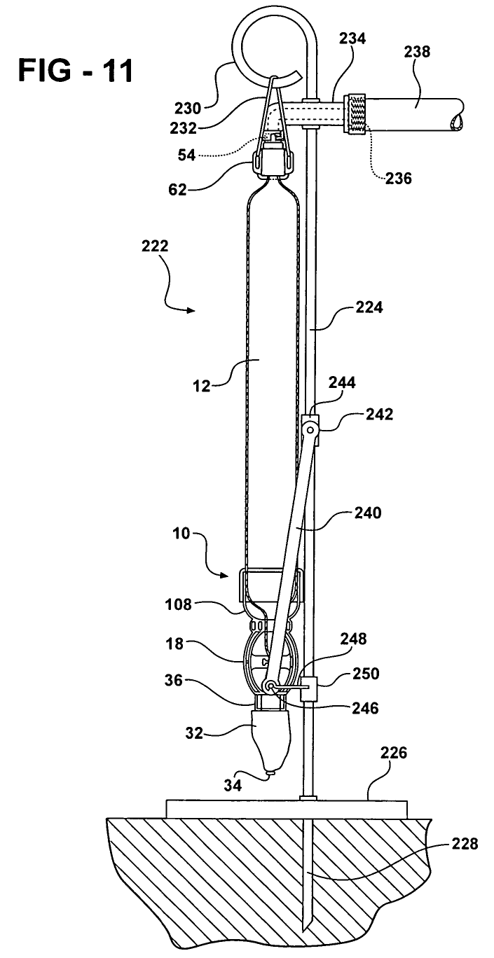

Referring to FIG. 11, an illustration is shown at 222 of a fill stand adapter for use with the water discharge toy according to the present invention. The fill stand 222 includes an upwardly extending and elongated body 224, supported by a pedestal 226 and including a ground stake 228 at a first end. An upwardly extending end of the elongated body 224 includes a looped portion 230, from which is suspended a strap or like support 232 which in turn engages the integral piece 62 of the water discharge toy 10.

A fill adapter 234 is arranged as a fixed portion proximate the upper end location of the fill stand and includes a fitting 236 to which is attached a garden hose 238 or the like. The fill adapter 234 secures at an opposite and downwardly configured end to the inlet plenum 54 of the discharge toy and such that the toy is arrayed in a substantially vertically disposed fashion upon being secured upon the fill stand.

To facilitate and accommodate refilling of the bladder 12, a stretcher arm 240 is secured pivotally 242 to the extending body 224 at one end and, at an opposite end 246, proximate the valve end and head portion of the water discharge toy. The pivot location 224 may further be adjusted by clamping to various positions along the extending body 224 and so that the water toy is pre-stretched to its final length prior to filling. A stretcher latch 248 extends from the end connection 246 and to another sleeve 250 located at a lowermost position along the body 224 and, prior to filling the bladder 12, both pivots and stretches to lengthen the toy and to ease the filling and expansion of the diameter of the bladder with fluid.

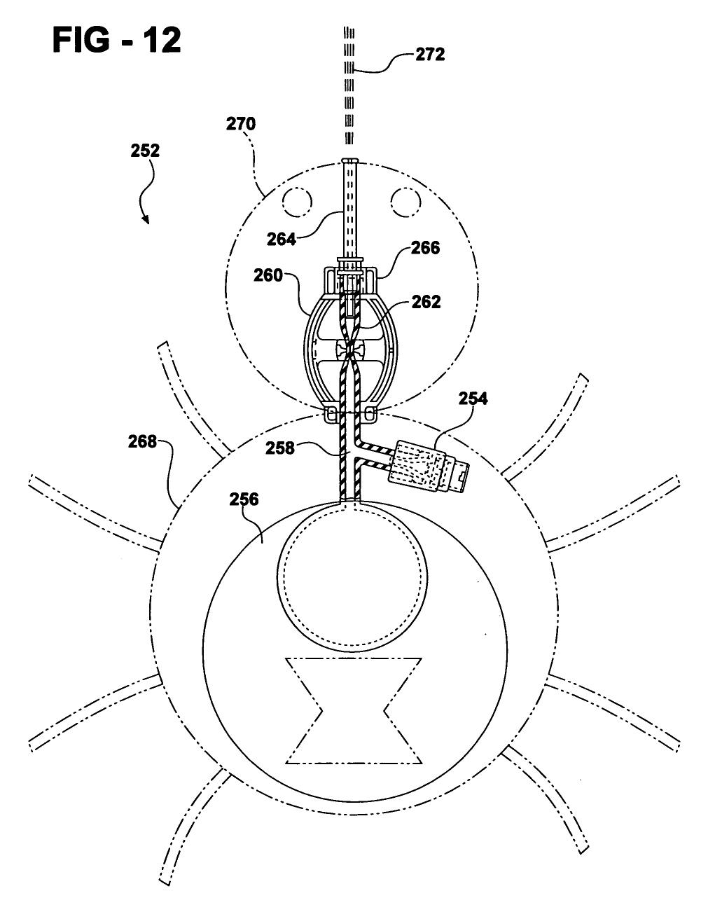

FIG. 12 illustrates, at 252, a water discharge toy according to a further preferred embodiment of the present invention and which in particular includes a sideways disposed fill port 254 and a rearward disposed and bulbous shaped elastic bladder 256. The fill port 254 extends to one side of a bladder aperture portion 258 extending from the elastic bladder 256. A check valve 260 is located at a terminating end 262 of the extending bladder aperture portion 258 and a nozzle lumen 264 is again affixed as part of an outlet orifice and associated compression fitting 266 forming portions of the check valve.

A decorative animal figure, see body 268 and head 270 in FIG. 12, is provided and is arrayed around the bulbous elastomeric bladder and control valve components, respectively. In particular, the decorative design according to this embodiment is that of a spider and, upon depressing the cantilevered springs and pinch members associated with the check valve 260, causes a stream of fluid 272 to be dispensed from the nozzle lumen 264.

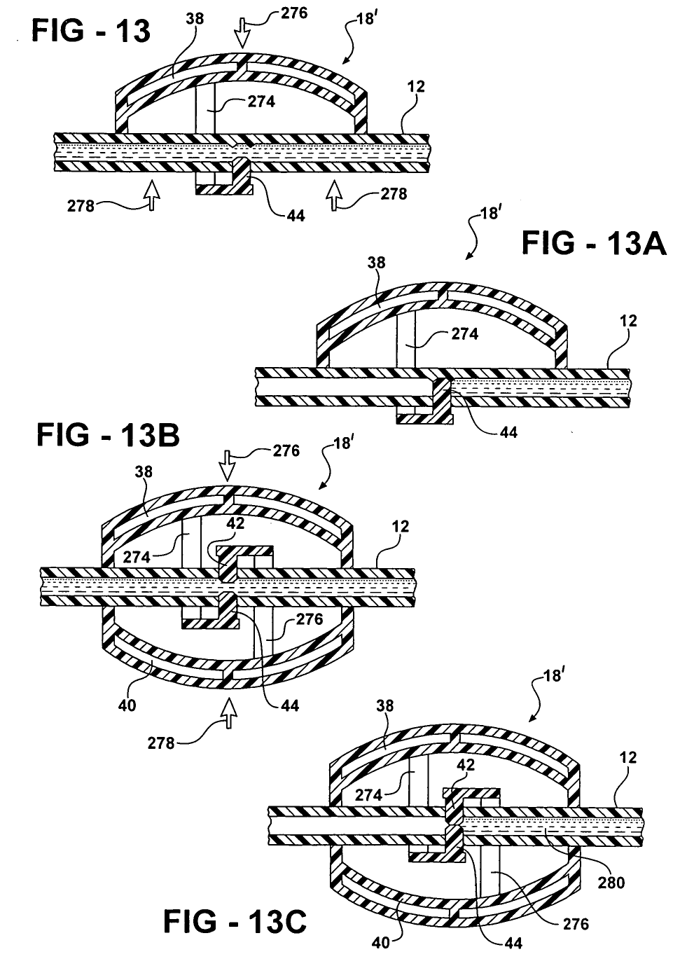

Referring to FIGS. 13-13C, a first series of sectional views are illustrated of the pressure sensitive flow control valve of the present invention. In particular, FIG. 13 illustrates a partial view of a first selected cantilevered spring 38 associated with a given variation 18′ of the control valve. The associated flow interrupting member 44 is interconnected to the spring 38 by a valve actuator blade 274 and actuates between an open position, as illustrated in FIG. 13 and resulting from the force applications illustrated by arrows 276 and 278, and the flow restricting position of FIG. 13A and by which the valve gate achieved by the members 42 and 44 establishes, in either opened or closed/interrupted positions, a fluid tight seal with the bladder 12.

Referring further to FIG. 13B, an assembled and cutaway illustration is shown of the interrupting members 42 and 44 in combination, see also second valve actuator blade 276, and in which the members are actuated (see again force vectors 276 and 278) to their separated and opened position, by which fluid flow passes through to an outlet orifice end of the control valve. Referring finally to FIG. 13C, the control valve is illustrated in a closed position, due to the absence of compression forces applied to the cantilevered springs, and by which the interrupting members 42 and 44 reassert their fluid stopping flow of the fluid, see at 280, through the check valve.

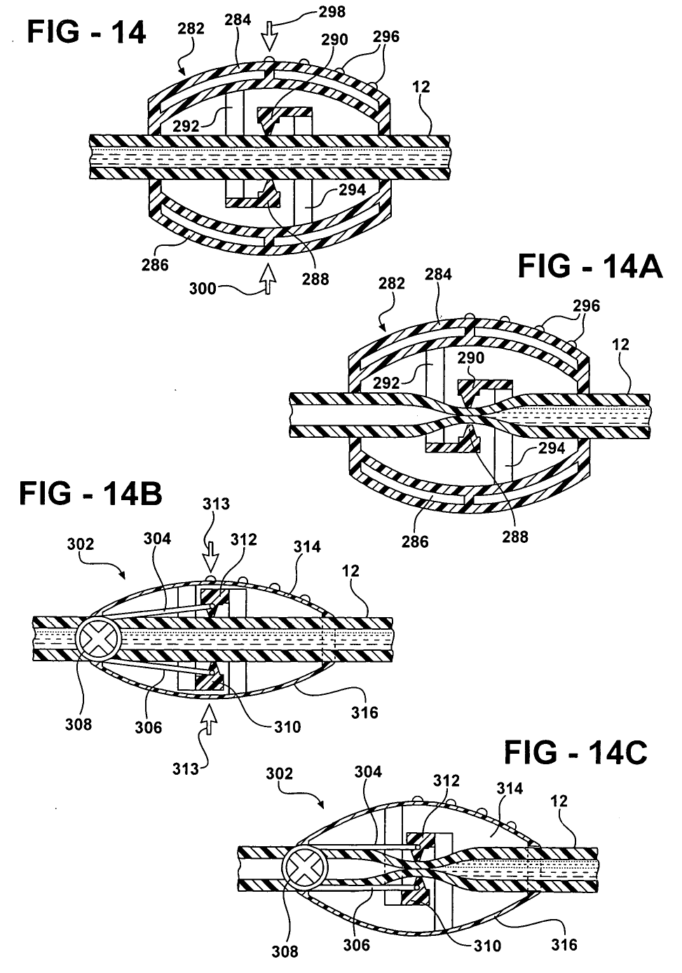

FIGS. 14-14C illustrate a yet further series of views of a pinch valve arrangement employed with a flow control valve according to the present invention; Referring to FIGS. 14 and 14A, the further variation of the control valve is illustrated at 282 and again includes cantilevered springs 284 and 286 to which are interconnected pinch members 288 and 290 and associated actuator blades 292 and 294. Additional features such as gripping ribs 296 are provided to enhance gripping and deflection of the cantilevered portions. As best again shown in FIG. 14, opposing force applications 298 and 300 result in the pinch members being retracted to the opened position and, as further shown in FIG. 14A, release of the force applications results in the pinch members reasserting their opposing contact in order to fluidly seal the elastomeric bladder and to prevent additional fluid flow therethrough.

FIGS. 14B and 14C illustrate a further variant of a check valve 302 in both opened and closed positions, respectively. In relevant part, the normally closed position is established in FIG. 14C through the provision of spring elements, see legs 304 and 306 which interconnect at coiled portion 308, and by which in particular the legs bias associated pinch members 310 and 312 in their inwardly and opposing engagement. Referring further to FIG. 14B, application of opposing forces (see opposing force vectors 313) on the deflecting handle portions, see at 314 and 316, causes the spring and spring legs 304 and 306 to forcibly retract and unseat the pinch members 310 and 312 from the elastic walled tube associated with the elastomeric bladder 12 and to permit fluid flow through the control valve.

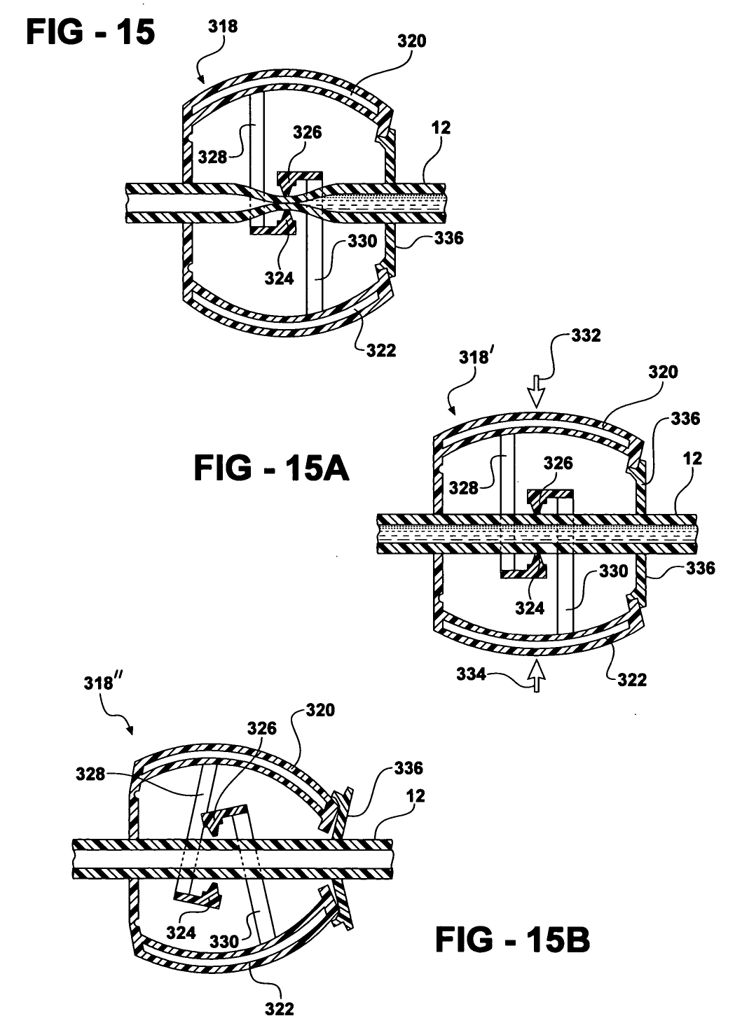

Referring to FIGS. 15, 15A and 15B, additional illustrations are shown of another variant of collapsible pinch valve associated with a flow control valve. The variant, illustrated at positions 318, 318′ and 318″ in succeeding FIGS. 15, 15A and 15B, is largely similar to those previously described and includes again a pair of cantilevered springs 320 and 322 which engage pinch members 324 and 326 through interconnected valve actuator blades 328 and 330.

As illustrated in the initial view of FIG. 15, the pinch members at rest engage and fluidly seal the elastic tube 12. Referencing further FIG. 15A, force application along directional vectors 332 and 334 causes the pinch members 324 and 326 to unseat from the elastic tube and for fluid flow to initiate. Note also frangible latching portion 336 which facilitates assembly and which is located at a rear end of the control valve. As fabricated, springs 320 and 322 are in the position illustrated in FIG. 15B. As the user pulls springs 320 and 322 outward, portion 336 is caused to latch. Thereafter, the valve works as shown in FIGS. 15 and 15A, and such that portion 336 should not collapse in use.

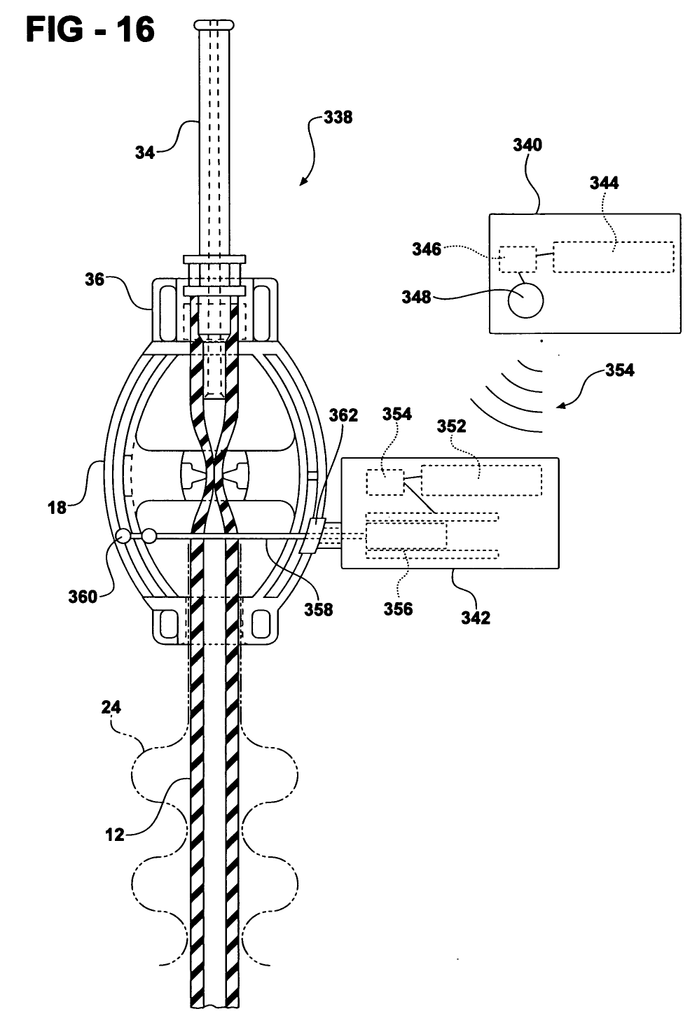

Referring to FIG. 16, an illustration is shown at 338 of a remote control transmitter 340 and receiver/driver unit 342 for remotely activating the control valve 18 of the water discharge toy. In particular, the remote transmitter 340 component includes a battery 344, transmitter controller 346 and on/off button 348. Upon being activated, the transmitter 340 issues a radio signal 350, which is received by the radio receiver/driver unit 342. The unit 342 includes a battery 352, driver unit 354, and actuable solenoid 356. Connected to and extending from the solenoid is a rod 358 which secures at an extending end 360 to a selected and oppositely facing cantilevered spring associated with the control valve 18. Upon actuating the unit 342, the rod 358 is retracted in a direction towards the attached unit 342, and in order to inwardly deflect the cantilevered springs towards one another; this being further assisted by a support 362 located upon the opposing cantilevered spring and being fixedly supported relative to the unit housing.

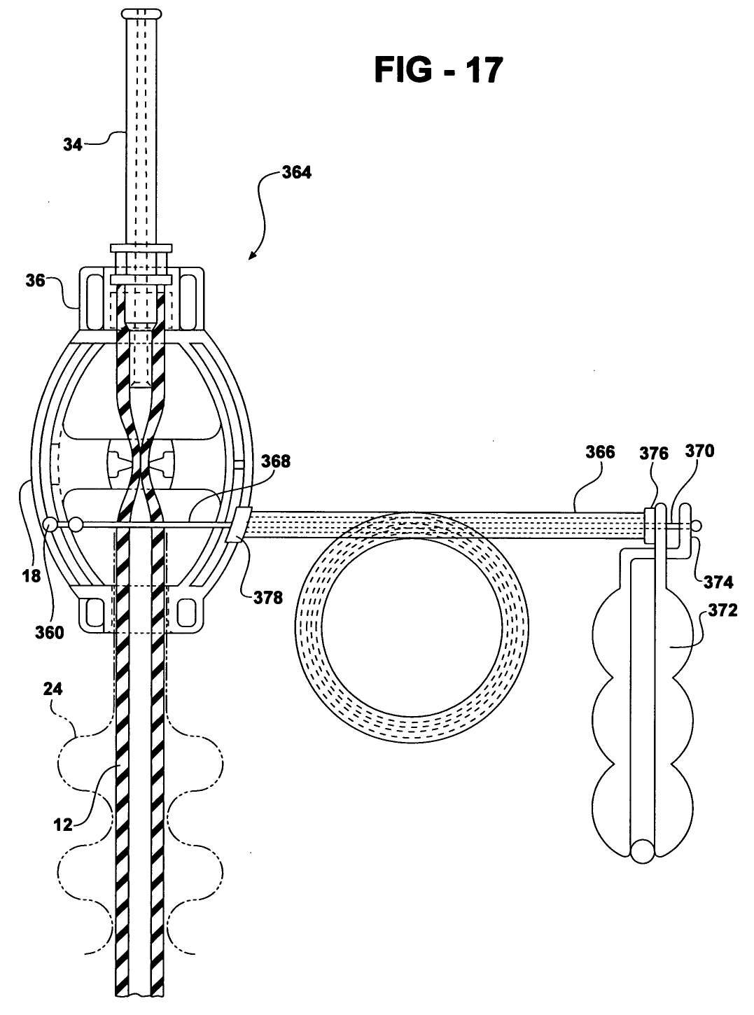

Referring now to FIG. 17, an illustration is provided at 364 of a remote control cable attachment for activating the water discharge toy. The control cable attachment is illustrated at 366 and is constructed as an internally hollowed and flexible member through which extends a flexible slidably translatable central coil, see further extending ends 368 and 370. A handheld cable actuator is illustrated at 372, in operative and pivoting engagement 374 with the associated end 370 of the coil (the outer flexible member 366 being secured at 376 to a stem portion of the handle).

As with the remote control variant of FIG. 16, a support 378 is provided at the opposite end of the cable attachment and through which projects the associated end 368 of the flexible and translatable central coil. The coil end 386 connects in the same fashion previously illustrated at 360 to the opposite facing cantilevered spring of the control valve and, upon actuating engagement of the handheld actuator 372, such as in a pivoting fashion, the cantilevered springs are inwardly directed towards one another by virtue of the retraction of the cable and the water discharge toy thus activated.

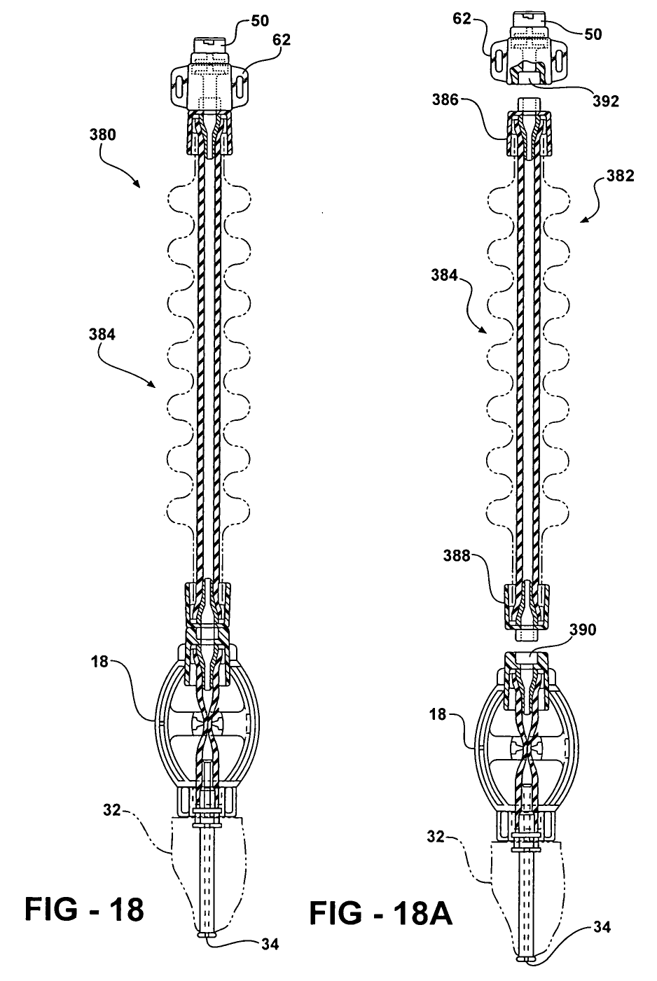

FIGS. 18 and 18A are assembled and exploded views, respectively shown at 380 and 382, of the water discharge toy. In particular, this particular variant employs a replaceable bladder assembly 384 and which, as best shown in FIG. 18A, includes compression fitting portion 386, associated with the one-way refill valve, and compression fitting portion 388 associated with the forwardly disposed check valve. The compression fitting portions 386 and 388 are configured to engage, such as through compression twist and lock or threadably engaging fashion, to the valve assembly and fill port assembly.

In particular, the forward fitting portion 388 engages with a pinch valve 390 with nozzle forming a part of the control valve and animal figurine head, whereas the rearward fitting portion 386 engages a suitable configuration formed into the integral component 392 of the one-way refill valve. In this manner, the sleeve and bladder is capable of being quickly detached and replaced with another identical or differently configured component.

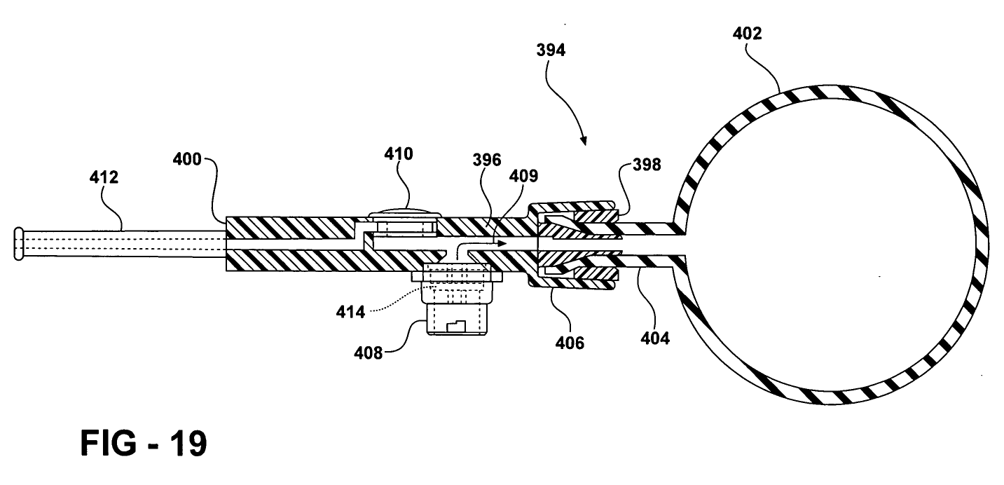

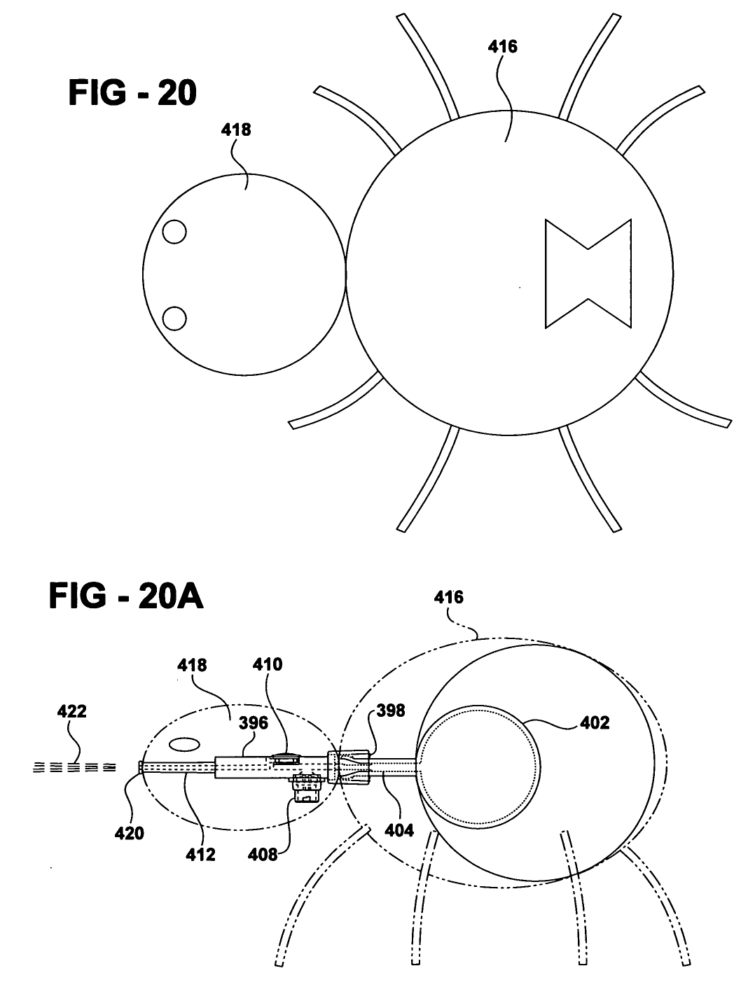

Referring finally to FIG. 19, as well as to succeeding FIGS. 20 and 20A, an illustration is shown at 394 (FIG. 19) of a water discharge toy according to a still further variant of the present invention. In particular, the toy includes an elongated and interiorly hollowed body 396 having a first end 398 and a second end 400. An elastomeric and substantially bulbous shaped bladder 402 is provided and includes an extended bladder aperture portion 404 interconnected with the first end 398 of the elongated body by a first compression fitting 406, this fitting 406 being described previously in detail and as providing for fluid flow from the elastomeric bladder 402.

A one-way flow valve 408 is illustrated and is integrally formed with the body 396 in operative communication with an intermediate location of the hollowed interior body 396. A fill adapter (not shown) engages the second compression fitting and valve 408 and provides a source of pressurized fluid through the body 396 and in a specified direction (see arrow 409) towards the rearwardly disposed bladder 402.

A control valve 410 communicates with a further location of the body 396, the control valve being actuated to fluidly communicate the contents of the elastomeric bladder 402 with an outflow orifice 412 extending from the second end 400 of the body and typically provided again as a nozzle lumen.

In the preferred variant, the one-way flow valve 408 further includes a flapper valve, see at 414, and which is displaceable relative to a valve seat and for establishing pressurized fluid flow into the bladder 402. The control valve 410 is further preferably constructed as a pushbutton valve and, upon being depressed, opens the interior body for fluid flow through the outlet orifice.

As is also again shown in FIGS. 20 and 20A, a decorative shaped covering, see body portion 416 and head portion 418, is applied in arrayed fashion around the elongated body and the bulbous shaped bladder. The decorative shaped covering further is provided, in the preferred variant illustrated, as a spider design including the head portion 418 exhibiting an aperture 420 (FIG. 20A) in alignment with an extending end of the nozzle lumen 412 and for permitting the issuing of an outlet stream 422.

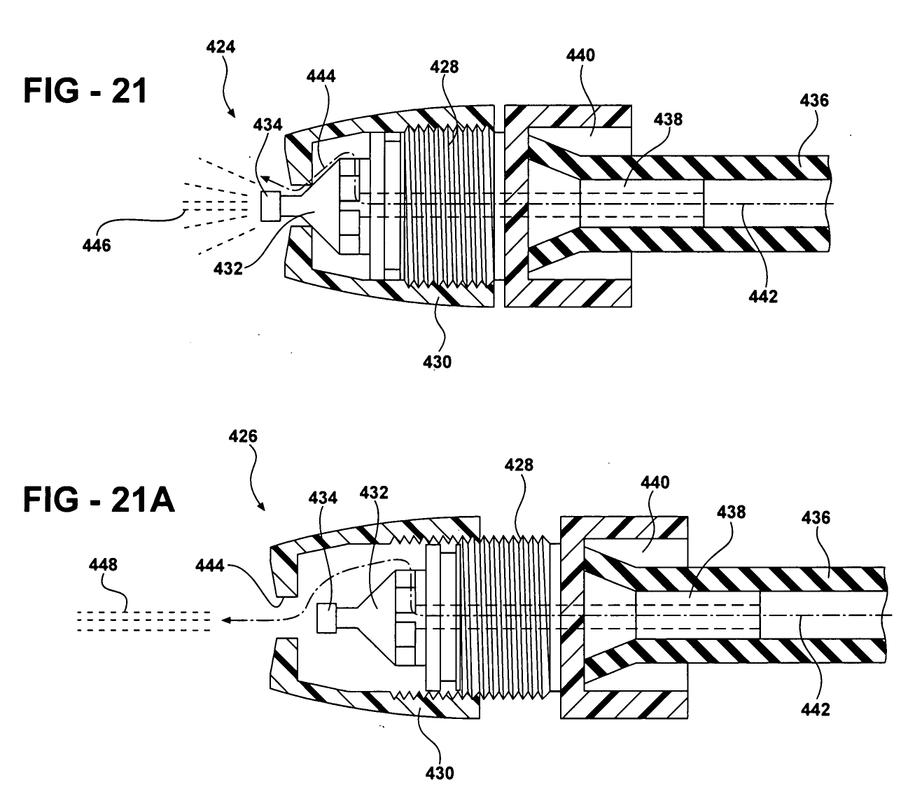

Referring finally to FIGS. 21 and 21A, sectional views are shown at 424 and 426, respectively, of a nozzle assembly associated with the water discharge toy and which facilitate conversion between a spray position 424 and a substantially collimated stream position 426. Referring first to FIG. 21, an exteriorly threaded nozzle body 428 is provided, about which is threadably rotatable and axially translatable an adjustment collar 430. A nozzle 432 is formed at a head of a valve gate 432 and is supplied with pressurized fluid via a bladder 436, nozzle lumen 438 and compression fitting 440 interconnecting the bladder 436/lumen 438 with the nozzle body 428.

The nozzle body 428 in FIG. 21 is illustrated in a substantially closed/tightened position whereby an internal stream of fluid 442 is routed in the manner illustrated and forcibly ejected through a constricted orifice 444 of the nozzle and in order to be distributed as a spray 446. Referring to FIG. 21A, the nozzle body 430 is further illustrated in a substantially opened/unscrewed condition and by which the fluid flow 442 is redirected through the orifice 444 as a substantially collimated stream.

Having described my invention, additional preferred embodiments will become apparent to those skilled in the art to which it pertains and without deviating from the scope of the appended claims.

I claim:

1. A water discharge toy, comprising:
an elongated and interiorly hollowed body having a first end and a second end;
an elastomeric and substantially bulbous shaped bladder having an extended bladder aperture portion interconnected with said first end;
said body further including an outflow orifice extending from said second end;
a one-way flow valve integrally formed with said body and adapted to being engaged by a fill adapter to provide a source of pressurized fluid to said elastomeric bladder; and
a control valve communicable with a further location of said body and being actuated to fluidly communicate said bladder with said outflow orifice.

2. The water discharge toy as described in claim 1, further comprising a first compression fitting for connecting said bladder aperture portion with said first end of said elongated body.

3. The water discharge toy as described in claim 2, said one-way flow valve further comprising a second compression fitting.

4. The water discharge toy as described in claim 1, said one-way flow valve further comprising a flapper valve displaceable relative to a valve seat and for establishing pressurized fluid flow into said elastomeric bladder.

5. The water discharge toy as described in claim 1, said control valve further comprising a pushbutton valve which, upon being depressed, accesses said interiorly hollowed body with said outflow orifice.

6. The water discharge toy as described in claim 1, further comprising a decorative shaped covering arrayed around said elongated shaped body and said bulbous shaped bladder.

7. The water discharge toy as described in claim 6, said decorative shaped covering further comprising a spider design including a head portion exhibiting an aperture in alignment with an extending nozzle lumen end of said outflow orifice.

8. The water discharge toy as described in claim 1, further comprising said control valve opening at a predetermined fluid pressure to prevent overfilling and over-pressurization.

9. The water discharge toy as described in claim 1, said outflow orifice further comprising a nozzle configured to issue said pressurized fluid in at least one of a stream and a mist spray.

10. A water discharge toy, comprising:
a three-dimensional shaped and interiorly hollowed body having a first end and a second end;
an elastomeric bladder with an extended bladder aperture portion interconnected with said first end of said body;
said body further including an outflow orifice extending from said second end;
a one-way flow valve integrally formed with said body and engaged by a fill adapter to provide a source of pressurized fluid to said elastomeric bladder; and
a control valve integrally formed with a further location of said body and further comprising a pushbutton valve which, upon being depressed, communicates said fluid filled bladder with said outflow orifice to issue said pressurized fluid in at least one of a stream and a mist spray.

11. The water discharge toy as described in claim 10, further comprising a first compression fitting for connecting said bladder aperture portion with said first end of said elongated body.

12. The water discharge toy as described in claim 11, said one-way flow valve further comprising a second compression fitting.

13. The water discharge toy as described in claim 10, said one-way flow valve further comprising a flapper valve displaceable relative to a valve seat and for establishing pressurized fluid flow into said elastomeric bladder.

14. The water discharge toy as described in claim 10, further comprising a decorative shaped covering arrayed around said elongated shaped body and said bulbous shaped bladder.

15. The water discharge toy as described in claim 14, said decorative shaped covering further comprising a spider design including a head portion exhibiting an aperture in alignment with an extending nozzle lumen end of said outflow orifice.

16. The water discharge toy as described in claim 10, further comprising said control valve opening at a predetermined fluid pressure to prevent overfilling and over-pressurization.
